(19) United States
(12) Patent Application Publication
(10) Pub. No.: US 2025/0168893 A1
(43) Pub. Date: May 22, 2025

(54) CONFIGURATION OF RANDOM ACCESS CHANNEL RESOURCES

(71) Applicant: Nokia Technologies Oy, Espoo (FI)

(72) Inventors: Halit Murat GÜRSU, Munich (DE); Ugur Baran ELMALI, Munich (DE); Malgorzata TOMALA, Wroclaw (PL); Ömer BULAKCI, Munich (DE)

(73) Assignee: Nokia Technologies Oy, Espoo (FI)

(21) Appl. No.: 18/840,251

(22) PCT Filed: Jan. 20, 2023
(86) PCT No.: PCT/EP2023/051304

§ 371 Date: Aug. 21, 2024

(30) Foreign Application Priority Data
Feb. 21, 2022 (FI) 20225154

(51) Int. Cl. H04W 74/0833; H04W 56/00

(52) U.S. Cl. CPC H04W 74/0833; H04W 56/002

(57) ABSTRACT

There is provided an apparatus comprising at least one processor; and at least one memory including computer program code, the at least one memory and the computer program code configured to, with the at least one processor, cause the apparatus to perform at least: receiving (410), from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features; determining (420), based on at least one of the one or more features, at least one preamble of the one or more preambles in a physical random access channel occasion corresponding to at least one synchronization signal block in the set of synchronization signal blocks; and transmitting (430), to the network node, the at least one preamble.

### FIELD

Various example embodiments relate to configuration of random access channel resources.

### BACKGROUND

Random access channel (RACH) procedure is the procedure where the UE wants to create an initial connection with the network. In contention based RACH, different user equipments may select the same resource, which may lead to a RACH collision.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising at least one processor; and at least one memory including computer program code, the at least one memory and the computer program code configured to, with the at least one processor, cause the apparatus to perform at least: receiving, from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features; determining, based on at least one of the one or more features, at least one preamble of the one or more preambles in a physical random access channel occasion corresponding to at least one synchronization signal block in the set of synchronization signal blocks; and transmitting, to the network node, the at least one preamble.

According to an embodiment, the one or more features comprise at least one of: coverage enhancement, network slicing, reduced capability, and small data transmission.

According to a second aspect, there is provided an apparatus comprising at least one processor; and at least one memory including computer program code, the at least one memory and the computer program code configured to, with the at least one processor, cause the apparatus to perform at least: transmitting, to a user equipment, at least one random access configuration for the user equipment to access to a radio access network, wherein the at least one random access configuration comprises a mapping between a set of synchronization signal blocks and one or more preambles in at least one physical random access channel occasion according to one or more features; and receiving, from the user equipment, at least one preamble of the one or more preambles.

According to a third aspect, there is provided a method comprising: receiving, by a user equipment from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features; determining, based on at least one of the one or more features, at least one preamble of the one or more preambles in a physical random access channel occasion corresponding to at least one synchronization signal block in the set of synchronization signal blocks; and transmitting, to the network node, the at least one preamble.

According to an embodiment, the one or more features comprise at least one of: coverage enhancement, network slicing, reduced capability, and small data transmission.

According to an embodiment, the mapping comprises: an indication of a starting physical random access channel occasion and a number of times that the set of synchronization signal blocks are to be mapped to at least one preamble of the one or more preambles in different physical random access channel occasions.

According to an embodiment, the mapping comprises: a number of preambles and a number of times that the set of synchronization signal blocks are to be mapped to at least one preamble of the one or more preambles in different physical random access channel occasions.

According to an embodiment, the mapping comprises a mask indicative of at least one physical random access channel occasion for the apparatus.

According to an embodiment, the mapping comprises an indication that the mapping between the set of synchronization signal blocks and at least one preamble of the one or more preambles in the at least one physical random access channel occasion is to be applied after applying the mask.

According to a fourth aspect, there is provided a method comprising: transmitting, by a network node to a user equipment, at least one random access configuration for the user equipment to access to a radio access network, wherein the at least one random access configuration comprises a mapping between a set of synchronization signal blocks and one or more preambles in at least one physical random access channel occasion according to one or more features; and receiving, from the user equipment, at least one preamble of the one or more preambles.

According to an embodiment, the mapping comprises: an indication of a starting physical random access channel occasion and a number of times that the set of synchronization signal blocks are to be mapped to at least one preamble of the one or more preambles in different physical random access channel occasions.

According to an embodiment, the mapping comprises: a number of preambles and a number of times that the set of synchronization signal blocks are to be mapped to at least one preamble of the one or more preambles in different physical random access channel occasions.

According to an embodiment, the mapping comprises a mask indicative of at least one physical random access channel occasion for the user equipment.

According to an embodiment, the mapping comprises an indication that the mapping between the set of synchronization signal blocks and at least one preamble of the one or more preambles in the at least one physical random access channel occasion is to be applied after applying the mask.

According to a fifth aspect, there is provided a computer program configured to, when executed by an apparatus, cause the apparatus to perform at least the method of the third aspect and any of the embodiments thereof.

According to a sixth aspect, there is provided a computer program configured to, when executed by an apparatus, cause the apparatus to perform at least the method of the fourth aspect and any of the embodiments thereof.

According to a further aspect, there is provided a computer readable medium comprising program instructions that, when executed by at least one processor, cause an apparatus to perform at least the method of the third aspect and any of the embodiments thereof.

According to a further aspect, there is provided a computer readable medium comprising program instructions that, when executed by at least one processor, cause an apparatus to perform at least the method of the fourth aspect and any of the embodiments thereof.

According to a further aspect, there is provided an apparatus comprising means for performing the method of the third aspect and any of the embodiments thereof.

According to a further aspect, there is provided an apparatus comprising means for performing the method of the fourth aspect and any of the embodiments thereof.

According to an embodiment, the means comprises at least one processor; and at least one memory including computer program code, the at least one memory and the computer program code configured to, with the at least one processor, cause the performance of the apparatus.

### BRIEF DESCRIPTION OF THE DRAWINGS

FIG. 1 shows, by way of example, a network architecture of communication system;

FIGS. 2a and 2b show, by way of example, random access channel (RACH) procedures;

FIG. 3 shows, by way of example, mapping between physical RACH occasions and synchronization signal blocks;

FIG. 4a shows, by way of example, a flowchart of a method;

FIG. 4b shows, by way of example, a flowchart of a method;

FIG. 5 shows, by way of example, mapping between physical random access channel occasions and synchronization signal blocks;

FIG. 6 shows, by way of example, mapping between physical random access channel occasions and synchronization signal blocks;

FIGS. 7a and 7b show, by way of examples, mapping between physical random access channel occasions and synchronization signal blocks;

FIG. 8 shows, by way of example, masking and mapping between physical random access channel occasions and synchronization signal blocks; and

FIG. 9 shows, by way of example, a block diagram of an apparatus.

### DETAILED DESCRIPTION

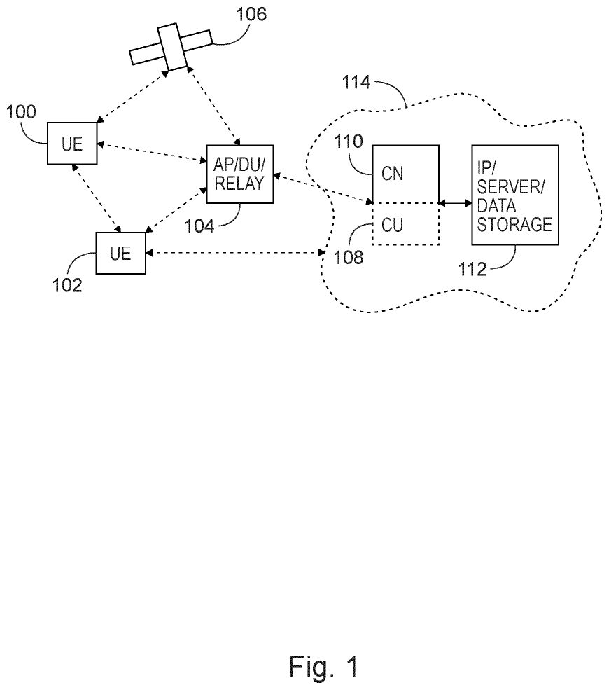

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices 100 and 102 configured to be in a wireless connection on one or more communication channels in a cell with an access node, such as gNB, i.e. next generation NodeB, or eNB, i.e. evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHZ) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz—cmWave, below 7 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 106 in the constellation may cover several satellite-enabled network entities that create on-ground cells. The on-ground cells may be created through an on-ground relay node 104 or by a gNB located on-ground or in a satellite.

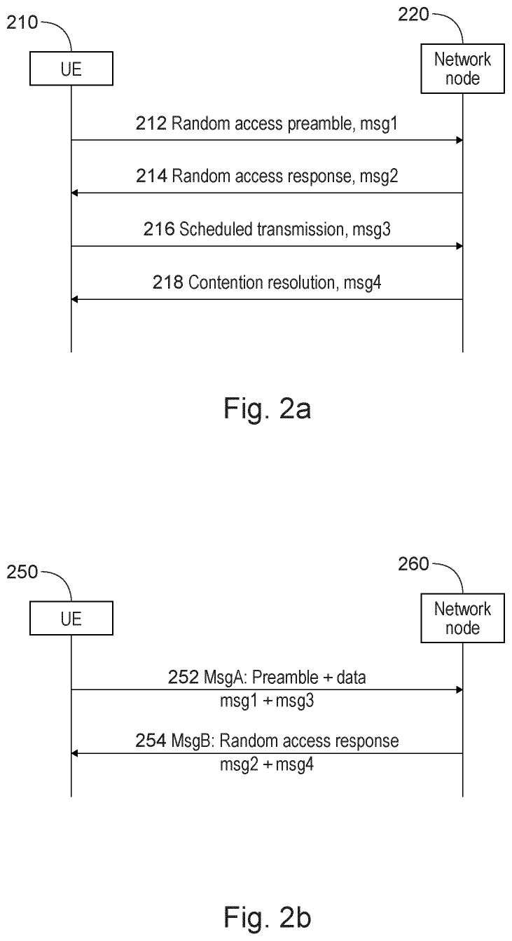

Random access channel procedure is the procedure where the UE wants to create an initial connection with the network. FIG. 2a shows, by way of example, a RACH procedure with four steps, and FIG. 2b shows, by way of example, a RACH procedure with two steps. Partitioning for 2-step RACH entails that the entire set of RACH resources is partitioned into two pools of resources. One pool is dedicated to a 2-step RACH and another pool is dedicated to a 4-step RACH. The UE may indicate whether it is going to use 4-step or 2-step RACH either in the random access preamble message 212 of FIG. 2a or in msgA 252 of FIG. 2b by selecting and transmitting using a RACH resource from a corresponding pool of resources.

The 4-step RACH of FIG. 2a is an example of a contention based random access (CBRA) procedure. In CBRA, different UEs may select the same resource and end up interfering with each other, leading to a RACH collision.

The UE 210 selects a preamble and sends 212 it to the network node 220, e.g. gNB, on a physical random access channel (PRACH). The UE then monitors the downlink channel to detect whether the network node answers the request to connect to the network.

The network node 220 sends 214 a random access response (RAR) indicating which preamble it is related to, the timing advance to be used, and a scheduling grant for transmission, for example. Scheduled transmission (msg3) 216 from the UE 210 to the network node 220, and the contention resolution message (msg4) 218 from the network node 220 to the UE 210 may be used to resolve a possible collision, wherein many UEs try to access the network in the same resource. For example, a unique identity of the network may be used in collision resolution.

When the random access procedure is completed, the UE may move to a connected state.

The 2-step RACH of FIG. 2b is an example of a contention free random access (CFRA) procedure, wherein contention free RACH resources are dedicated to a given UE. The msgA 252 comprises the preamble and the data, and may be represented as a combination of msg1 and msg3. The msgB 254 comprises the RAR and may be represented as a combination of msg2 and msg4.

Further partitioning of the RACH resources is being considered for features supported in the radio access network such as coverage enhancement (CovEnh), slicing, reduced capabilities (RedCap) both in radio resource control (RRC) idle/inactive and RRC connected, and small data transmission (SDT). A feature may be a capability from UE perspective, so that a UE might be capable to support a feature but not capable to support another feature. Thus, the network can identify the feature based on the preamble or RACH occasion used by the UE.

Features listed above as examples are considered in 3GPP Rel. 17. In principle ideas from the disclosure can be applied for other features developed in other releases or as other UE capabilities.

In the following, RACH indications or reasons for partitioning are given for CBRA for features CovEnh, Slicing, RedCap and SDT.

CovEnh indicates the need for coverage enhancement to the network. For example, coverage enhancement may be needed for request of repetition of the scheduled transmission (msg3).

Slicing indicates the need for prioritization and isolation of a slice, including RACH isolation, to the network.

RedCap RRC idle/inactive indicates the reduced capabilities of the UE to the network. The network may then adapt subsequent transmissions accordingly.

RedCap RRC connected allows the network to limit the impact of the UEs with reduced capabilities to other UEs.

SDT indicates a request for a larger size of msg3, or msgA in case of 2-step RACH, and SDT procedure when compared to regular msg3/msgA size for non-SDT/legacy resume.

For CFRA, the feature of slicing is an indication to isolate or prioritize access of one slice from another. UE may be configured with two different CFRA resources for separate quality of service (QOS). The features of RedCap and CovEnh indicate that feature specific PRACH resources may be needed due to physical layer constraints.

The RACH resources define the time and frequency resources that may be used by the UE for random access. The RACH resources comprise the RACH occasions in time (ROs) and RACH preambles.

A preamble is sent by the UE to the network node over PRACH channel to obtain UL synchronization. The preamble comprises a cyclic prefix (CP) and a preamble sequence. When a UE transmits a PRACH preamble, it transmits with a specific pattern, or sequence, which may be considered as a signature. In each NR cell, there are a total of 64 preamble sequences, or signatures, available. In contention based random access (CBRA), once the UE determines a suitable RO it will randomly select one of the valid preambles among the available ones, to be transmitted in the RO, as configured by the network. It may be that several UEs select the same preamble. In the disclosure, a PRACH preamble or a RACH preamble is denoted as a preamble, for simplicity.

PRACH configuration indicates the number of ROs within a RACH configuration. Each feature combination mapped to a RACH partition is indicated in the configuration with the number of preambles. For example, a parameter startPreambleForThisPartition-r17 may indicate the ordinal number of the starting partition, and a parameter nrofPreamblesForThisPartition may indicate the number of preambles. In addition, mapping of the synchronization signal block (SSB) specific resources may be signalled through the parameter ssb-SharedRO-MaskIndex-r17. The ssb-SharedRO-MaskIndex-r17 re-uses a masking index approach which is intended for the connected mode UEs. This masking approach has been designed such that preamble resources for only one SSB is indicated to the UE.

For feature specific PRACH resources, PRACH resources shall be present in all SSBs for all feature combinations. Thus, the masking approach intended for the connected mode UEs might not be applicable for feature specific PRACH resources, when all SSBs are not present in a single PRACH occasion. According to RAN2 agreement, preambles for a particular feature combination shall be present in all SSB. Thus, the SSB mask designed to mask RO resources per SSB is not applicable for feature specific PRACH resources.

The parameter ssb-SharedRO-MaskIndex-r17 may be an integer from 0 to 15. The mask index indicates a subset of ROs, wherein preambles are allocated for a given feature combination. The field of mask index may be configured when there is more than one RO per SSB. If the field is absent, or have the value of zero (0), and the 4-step RACH and 2-step RACH have shared ROs, then all ROs are shared. Table 7.4-1 of TS 38.321 gives the PRACH mask index values and corresponding allowed PRACH occasion(s) of SSB.

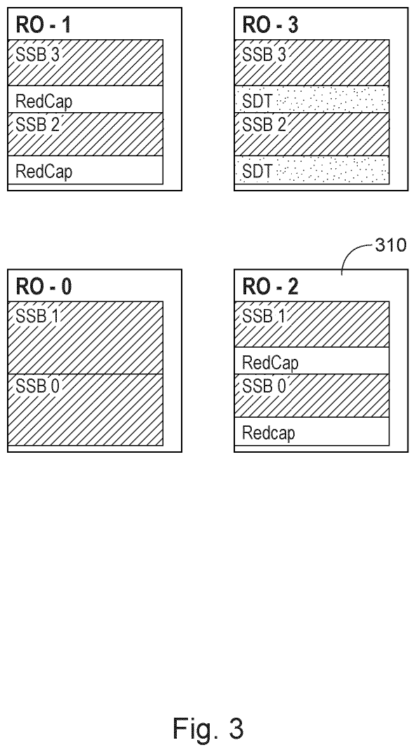

Let us consider a scenario, wherein the ssb-SharedRO-MaskIndex-r17=2 (RO2), and there are 4 SSBs (SSB0, SSB1, SSB2, SSB3), whereof 2 SSBs are mapped to one RO, as shown in FIG. 3.

That is, the allowed PRACH occasion is RO2 310 and subsequently the UE only would have access to SSBs that are mapped to RO2.

SDT feature supporting UEs at SSB0 or SSB1 will not have any feature specific RACH resource. This will limit the use of the feature specific RACH.

When more than one RO would be needed to map a feature completely to all SSBs, the SSB mask designed to mask RO resources per one single SSB is not applicable.

In principle, random access configuration (RACH configuration) indicates to the UE which physical random access channel resources within the system bandwidth UE is allowed to use. The physical random access channel (PRACH) resources are indicated with PRACH configuration index that is pre-configured to the UE. The physical random access channel resources comprises PRACH occasions, that indicates a group of preambles allocated in a set of resource blocks. PRACH configuration index indicates how many PRACH occasions exists in time domain. Likewise, the MSG1 frequency division multiplexing (MSG1-FDM) parameter included in the random access configuration indicates how many PRACH occasions exists in the frequency domain. The random access configuration configures the UE with the parameters related to the feature/feature combination specific physical random access channel resources, that can be called feature/feature combination specific PRACH occasion or random access partition. The random access configuration maps a specific meaning to preambles within each PRACH occasion. The allocation of meaning is called mapping procedure. The mapping enables the network to identify the meaning conveyed by the UE with the use of a specific preamble. For instance, a UE may use a preamble 1 in PRACH occasion 2. Using the configuration in random access configuration UE may have selected this preamble, to indicate SSB beam 3 and the feature combination of SDT and RedCap.

Methods are provided for enhanced masking mechanism for feature specific PRACH resources to guarantee that a feature specific UE would have access to many or all SSB specific PRACH resources. It is assumed that the UE is in idle mode or inactive mode.

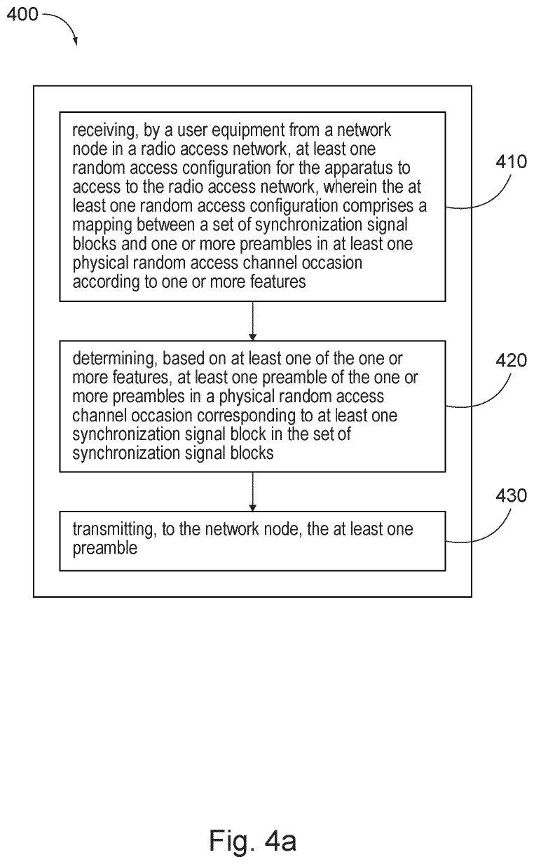

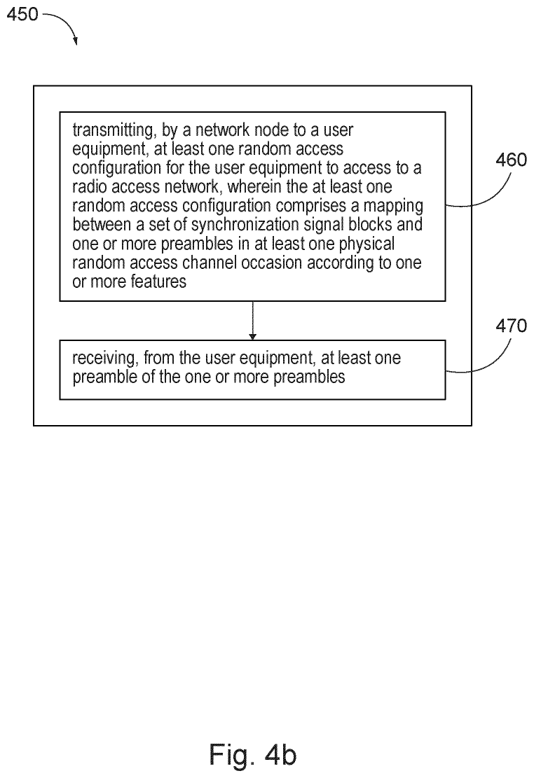

FIG. 4a shows, by way of example, a flowchart of a method. The method 400 may be performed by a UE, or by a control device configured to control the functioning thereof, when installed therein. The method 400 comprises receiving 410, by a user equipment from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features. The method 400 comprises determining 420, based on at least one of the one or more features, at least one preamble of the one or more preambles in a physical random access channel occasion corresponding to at least one synchronization signal block in the set of synchronization signal blocks. The method 400 comprises transmitting 430, to the network node, the at least one preamble.

FIG. 4b shows, by way of example, a flowchart of a method. The method 450 may be performed by a network node, or by a control device configured to control the functioning thereof, when installed therein. The method 450 comprises transmitting 460, by a network node to a user equipment, at least one random access configuration for the user equipment to access to a radio access network, wherein the at least one random access configuration comprises a mapping between a set of synchronization signal blocks and one or more preambles in at least one physical random access channel occasion according to one or more features. The method 450 comprises receiving 470, from the user equipment, at least one preamble of the one or more preambles.

The methods as disclosed herein provide enhanced masking mechanism for feature specific PRACH resources to guarantee that a feature specific UE will have access to all SSB specific PRACH resources.

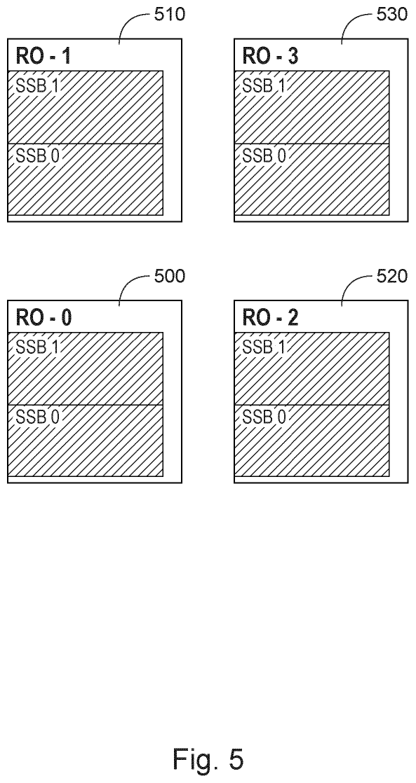

FIG. 5 shows, by way of example, mapping between random access channel occasions, RO0 500, RO1 510, RO2 520, RO3 530 and synchronization signal blocks SSB0, SSB1. Let us consider that the initial RO structure is according to the example of FIG. 5.

UE may receive, from the network node, random access configuration comprising a mapping between the ROs and SSBs. The UE may select, based on device capability of the UE, at least one SSB of the set of valid SSBs. The UE may determine at least one preamble corresponding to the selected at least one SSB, and transmit the at least one preamble using the configured RO(s).

For example, the SSB mask may be indicated with a starting RO and a number of times the SSBs are to be covered by the feature specific PRACH resource. UE may create the mapping of the SSB specific PRACH resources for the feature it is interested in. UE may use these PRACH resources for feature specific PRACH access.

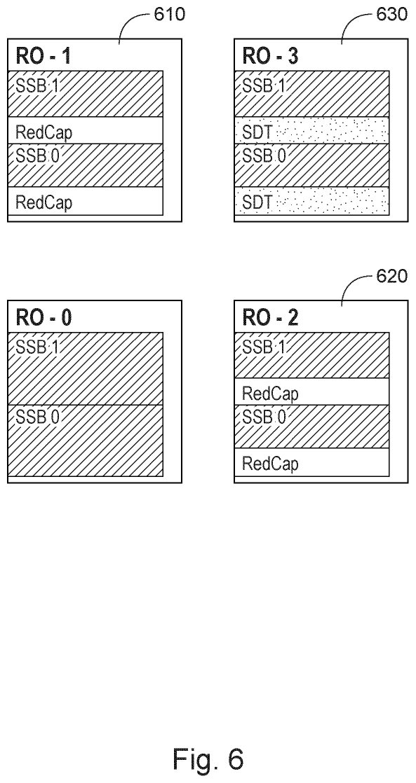

FIG. 6 shows, by way of example, mapping between physical random access channel occasions (ROs) and synchronization signal blocks (SSBs). In other words, mapping of ROs to feature specific random access channel (RACH) resources is shown. For example, the received mapping information for a feature RedCap may indicate RO1 610 as the starting RO and that the SSBs are to be covered two (2) times by the feature specific PRACH resource. Thus, RedCap has feature specific resources also in RO2 620. Number of preambles is 1 to 5.

For a feature SDT, the received mapping information may indicate RO3 630 as the starting RO and that the SSBs are to be covered one time. Number of preambles is 1 to 5.

Thus, for feature specific PRACH mapping, e.g. for each feature specific PRACH mapping, the mapping starts from the RO indicated and covers the SSBs x times, wherein the x is the number indicated in the mapping information. In case there are not enough SSB specific PRACH resources available, the mapping stops.

As another example, the mapping may be configured to start from RO-0 for each feature specific PRACH resource. Thus, the SSB mask may be indicated by the number of preambles and the number of times the SSBs are mapped for each feature specific PRACH resource. UE may create the mapping of SSB specific PRACH resources to all feature specific PRACH resources. UE may select the relevant PRACH resource for the feature it is interested in.

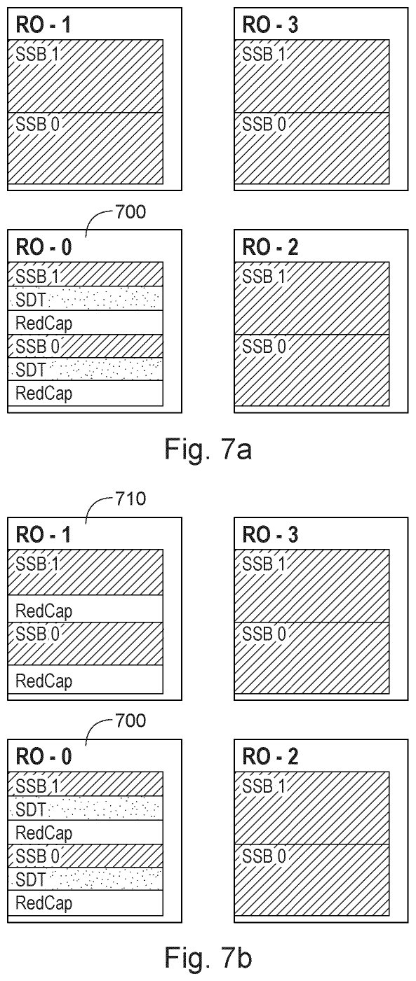

FIGS. 7a and 7b show, by way of examples, mapping between physical random access channel occasions (ROs) and synchronization signal blocks (SSBs). In other words, mapping of SSB specific PRACH resources to feature specific PRACH resources is shown. For example, the received mapping information for a feature combination RedCap may indicate that the number of preambles is five (5) and that SSBs are to be mapped two (2) times for each feature specific PRACH resource.

For a feature combination SDT, the received mapping information may indicate that the number of preambles is five (5) and that SSBs are to be mapped one time for the feature specific PRACH resource.

The available preambles after legacy preambles are mapped to the feature once to cover all SSBs. Then, an iteration over the next feature may take place. If one feature is to be mapped more than once to SSBs, it is mapped to the SSBs after each feature is mapped at least once to all SSBs.

FIG. 7a shows the first iteration to map all SSB specific PRACH resources to feature specific PRACH resources. That is, the features RedCap and SDT are mapped once to all SSBs (SSB0 and SSB1) in RO0 700.

The mapping moves from one RO to another if there is not enough preambles left to be used by a feature specific PRACH partition. For instance if there are 3 preambles left in a partition but the number of preambles for a feature is 5, then this feature is mapped to next RO or next SSB specific PRACH resources.

FIG. 7b shows the second iteration to map all SSB specific PRACH resources to feature specific PRACH resources. That is, the feature RedCap with mapping information “2” is mapped to the SSBs of RO1 710, in addition to RO0 700.

The SSB mask may be used to indicate within a feature combination, which ROs are used for which slice group.

As a further example, SSB to RO mapping may be done after the mask is applied. In this case, a feature specific SSB to RO mapping is indicated. For example, for RedCap, one RO may be mapped to all SSBs. This guarantees that after masking is applied, there are PRACH resources allocated to all SSBs.

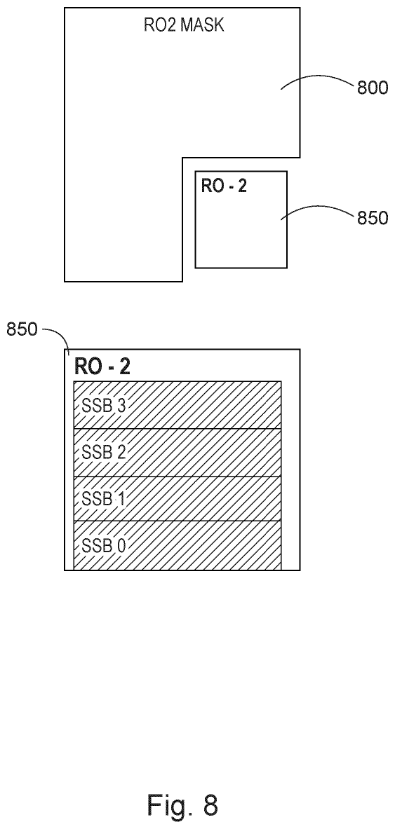

FIG. 8 shows, by way of example, masking and mapping between physical random access channel occasions and synchronization signal blocks. In other words, mapping of SSB specific PRACH resources to RO is shown. First, a mask 800 is applied before SSB mapping is performed. Then, the SSB to RO mapping is performed. For example, SSB0, SSB1, SSB2 and SSB3 are mapped to RO2 850. The SSB to RO mapping distributes the number of preambles available in the RO equally to all SSBs to avoid any SSB being left out after the mapping.

In case the masking is applied after SSB mapping, it may be that some of the SSBs may be left out of the mask. Thus, UE would not have access to the SSB specific resources.

When the masking is applied before SSB mapping, US masks some ROs, and after masking, the UE sees those ROs that are not masked. That is, the UE see only some ROs. Thus, UE is enabled to map the SSBs to those ROs that it has access to. This way, SSBs are not left out through the masking procedure.

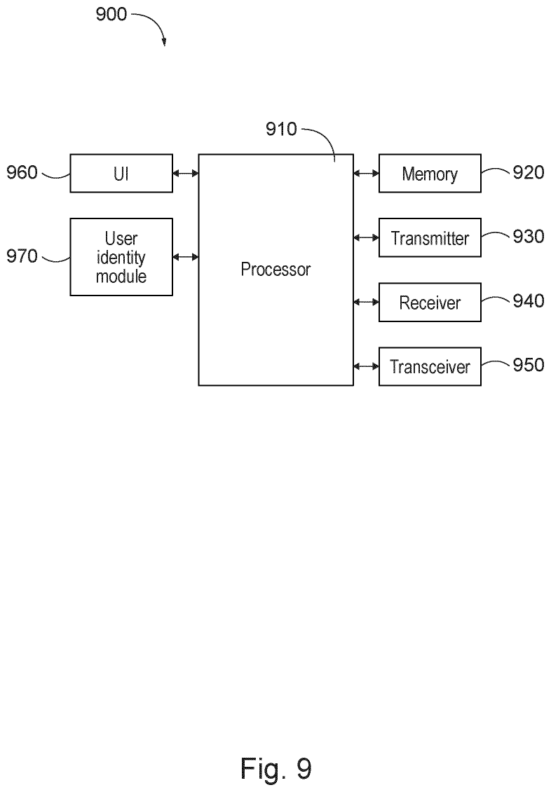

FIG. 9 shows, by way of example, an apparatus capable of performing the method as disclosed herein. Illustrated is device 900, which may comprise, for example, a mobile communication device such as a UE or mobile 100 of FIG. 1 or a network node such as an access node 104 of FIG. 1. Comprised in device 900 is processor 910, which may comprise, for example, a single- or multi-core processor wherein a single-core processor comprises one processing core and a multi-core processor comprises more than one processing core. Processor 910 may comprise, in general, a control device. Processor 910 may comprise more than one processor. Processor 910 may be a control device. A processing core may comprise, for example, a Cortex-A8 processing core manufactured by ARM Holdings or a Steamroller processing core designed by Advanced Micro Devices Corporation. Processor 910 may comprise at least one Qualcomm Snapdragon and/or Intel Atom processor. Processor 910 may comprise at least one application-specific integrated circuit, ASIC. Processor 910 may comprise at least one field-programmable gate array, FPGA. Processor 910 may be means for performing method steps in device 900. Processor 910 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a user equipment or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 900 may comprise memory 920. Memory 920 may comprise random-access memory and/or permanent memory. Memory 920 may comprise at least one RAM chip. Memory 920 may comprise solid-state, magnetic, optical and/or holographic memory, for example. Memory 920 may be at least in part accessible to processor 910. Memory 920 may be at least in part comprised in processor 910. Memory 920 may be means for storing information. Memory 920 may comprise computer instructions that processor 910 is configured to execute. When computer instructions configured to cause processor 910 to perform certain actions are stored in memory 920, and device 900 overall is configured to run under the direction of processor 910 using computer instructions from memory 920, processor 910 and/or its at least one processing core may be considered to be configured to perform said certain actions. Memory 920 may be at least in part external to device 900 but accessible to device 900.

Device 900 may comprise a transmitter 930. Device 900 may comprise a receiver 940. Transmitter 930 and receiver 940 may be configured to transmit and receive, respectively, information in accordance with at least one cellular or non-cellular standard. Transmitter 930 may comprise more than one transmitter. Receiver 940 may comprise more than one receiver. Transmitter 930 and/or receiver 940 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 900 may comprise a near-field communication, NFC, transceiver 950. NFC transceiver 950 may support at least one NFC technology, such as NFC, Bluetooth, Wibree or similar technologies.

Device 900 may comprise user interface, UI, 960. UI 960 may comprise at least one of a display, a keyboard, a touchscreen, a vibrator arranged to signal to a user by causing device 900 to vibrate, a speaker and a microphone. A user may be able to operate device 900 via UI 960, for example to accept incoming telephone calls, to originate telephone calls or video calls, to browse the Internet, to manage digital files stored in memory 920 or on a cloud accessible via transmitter 930 and receiver 940, or via NFC transceiver 950, and/or to play games.

Device 900 may comprise or be arranged to accept a user identity module 970. User identity module 970 may comprise, for example, a subscriber identity module, SIM, card installable in device 900. A user identity module 970 may comprise information identifying a subscription of a user of device 900. A user identity module 970 may comprise cryptographic information usable to verify the identity of a user of device 900 and/or to facilitate encryption of communicated information and billing of the user of device 900 for communication effected via device 900.

Processor 910 may be furnished with a transmitter arranged to output information from processor 910, via electrical leads internal to device 900, to other devices comprised in device 900. Such a transmitter may comprise a serial bus transmitter arranged to, for example, output information via at least one electrical lead to memory 920 for storage therein. Alternatively to a serial bus, the transmitter may comprise a parallel bus transmitter. Likewise processor 910 may comprise a receiver arranged to receive information in processor 910, via electrical leads internal to device 900, from other devices comprised in device 900. Such a receiver may comprise a serial bus receiver arranged to, for example, receive information via at least one electrical lead from receiver 940 for processing in processor 910. Alternatively to a serial bus, the receiver may comprise a parallel bus receiver.

Processor 910, memory 920, transmitter 930, receiver 940, NFC transceiver 950, UI 960 and/or user identity module 970 may be interconnected by electrical leads internal to device 900 in a multitude of different ways. For example, each of the aforementioned devices may be separately connected to a master bus internal to device 900, to allow for the devices to exchange information. However, as the skilled person will appreciate, this is only one example and depending on the embodiment various ways of interconnecting at least two of the aforementioned devices may be selected.

1. An apparatus comprising at least one processor; and at least one memory including computer program code, the at least one memory and the computer program code configured to, with the at least one processor, cause the apparatus to perform at least:
receiving, from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features;
determining, based on at least one of the one or more features, at least one preamble of the one or more preambles in a physical random access channel occasion corresponding to at least one synchronization signal block in the set of synchronization signal blocks; and
transmitting, to the network node, the at least one preamble.

2. The apparatus of claim 1, wherein the one or more features comprise at least one of: coverage enhancement, network slicing, reduced capability, and small data transmission.

3. The apparatus of claim 1, wherein the mapping comprises:
an indication of a starting physical random access channel occasion and a number of times that the set of synchronization signal blocks are to be mapped to at least one preamble of the one or more preambles in different physical random access channel occasions.

4. The apparatus of claim 1, wherein the mapping comprises:
a number of preambles and a number of times that the set of synchronization signal blocks are to be mapped to at least one preamble of the one or more preambles in different physical random access channel occasions.

5. The apparatus of claim 1, wherein the mapping comprises a mask indicative of at least one physical random access channel occasion for the apparatus.

6. The apparatus of claim 5, wherein the mapping comprises an indication that the mapping between the set of synchronization signal blocks and at least one preamble of the one or more preambles in the at least one physical random access channel occasion is to be applied after applying the mask.

7. An apparatus comprising at least one processor; and at least one memory including computer program code, the at least one memory and the computer program code configured to, with the at least one processor, cause the apparatus to perform at least:
transmitting, to a user equipment, at least one random access configuration for the user equipment to access to a radio access network, wherein the at least one random access configuration comprises a mapping between a set of synchronization signal blocks and one or more preambles in at least one physical random access channel occasion according to one or more features; and
receiving, from the user equipment, at least one preamble of the one or more preambles.

8. The apparatus of claim 7, wherein the one or more features comprise at least one of: coverage enhancement, network slicing, reduced capability, and small data transmission.

9. The apparatus of claim 7, wherein the mapping comprises:
an indication of a starting physical random access channel occasion and a number of times that the set of synchronization signal blocks are to be mapped to at least one preamble of the one or more preambles in different physical random access channel occasions.

10. The apparatus of claim 7, wherein the mapping comprises:
a number of preambles and a number of times that the set of synchronization signal blocks are to be mapped to at least one preamble of the one or more preambles in different physical random access channel occasions.

11. The apparatus of claim 7, wherein the mapping comprises a mask indicative of at least one physical random access channel occasion for the user equipment.

12. The apparatus of claim 11, wherein the mapping comprises an indication that the mapping between the set of synchronization signal blocks and at least one preamble of the one or more preambles in the at least one physical random access channel occasion is to be applied after applying the mask.

13. A method comprising:
receiving, by a user equipment from a network node in a radio access network, at least one random access configuration for the apparatus to access to the radio access network, wherein the at least one random access configuration comprises a mapping between a set of synchronization signal blocks and one or more preambles in at least one physical random access channel occasion according to one or more features;
determining, based on at least one of the one or more features, at least one preamble of the one or more preambles in a physical random access channel occasion corresponding to at least one synchronization signal block in the set of synchronization signal blocks; and
transmitting, to the network node, the at least one preamble.

14-16. (canceled)
